(19) United States
(12) Patent Application Publication
(10) Pub. No.: US 2025/0251055 A1
(43) Pub. Date: Aug. 7, 2025

(54) Irrigation Device, Valve Assembly, And Outlet

(71) Applicant: Rain Bird Corporation, Azusa, CA (US)

(72) Inventors: Randall Dennis Bousfield, Tucson, AZ (US); Ray Samuel Peppiatt, Oro Valley, AZ (US)

(21) Appl. No.: 19/190,198

(22) Filed: Apr. 25, 2025

Related U.S. Application Data
(63) Continuation of application No. 17/532,604, filed on Nov. 22, 2021.

(51) Int. Cl. F16K 27/04; A01G 25/16

(52) U.S. Cl. CPC F16K 27/041; A01G 25/165

(57) ABSTRACT

An irrigation valve assembly is provided, such as for use in a hose end timer or other irrigation device. In one form, the irrigation valve assembly includes an inlet, an outlet, and a molded valve body coupled to the inlet and the outlet and defining a flow passage from the inlet to the outlet. The inlet couples the irrigation valve assembly to a water source. The outlet includes a metal outlet body including a threaded portion, such as for coupling to a house. The metal outlet body includes at least one projection embedded at least partially into the molded valve body for coupling the metal outlet body to the molded valve body. An irrigation device and an outlet for an irrigation device are also provided.

### CROSS-REFERENCE TO RELATED APPLICATION(S)

This application is a continuation application of U.S. application Ser. No. 17/532,604, filed Nov. 22, 2021, which is incorporated by reference herein in its entirety.

### FIELD

This invention relates generally to irrigation devices and, more particularly, to valve assemblies and outlets suitable for use in irrigation devices.

### BACKGROUND

Irrigation devices are generally known in the field of irrigation for use in delivering irrigation water from water sources to desired areas. One example of an irrigation device is a hose end timer, which is generally known for use in delivering irrigation water at scheduled times and time intervals, thereby conserving water. In some forms, the body of the hose end timer is formed of molded plastic for convenience of manufacturing and use by consumers. The hose end timer is generally disposed at a water source and controls the flow of water from the water source via a valve. Water may be delivered at a controlled rate and at a scheduled time through a hose to emission devices, which, in turn, irrigate vegetation or targeted terrain.

A hose end timer may be connected at one end to a faucet spigot through which water is supplied. The other end of the hose end timer may be connected to a hose for delivery of water to emission devices. The hose end timer needs to have secure couplings at both ends in order to avoid leakage.

For hose end timers, it has been observed that, over time, the threaded ends of the hose end timer may deteriorate or become damaged. When fastening the hose end timer to either the faucet spigot or hose, it has been observed that constant tightening (and possibly overtightening) of the ends of the hose end timer may lead to wear and tear or cross-threading. It has also been observed that the threaded ends may become damaged when the hose end timer is first installed or due to instances of rough handling. In response to this damage, however caused, the hose end timer may leak significantly or even stop functioning properly.

It is desirable to avoid having to replace irrigation devices due to stress or damage at the ends of the irrigation device. Thus, there is a need for an irrigation device where threaded ends will resist this stress or damage and that will thereby extend the useful life of the irrigation device. Further, there is a need for an irrigation device where these threaded ends can be formed in combination with the molded plastic body of the device.

### BRIEF DESCRIPTION OF THE DRAWINGS

FIG. 1 is a perspective view of an embodiment of a hose end timer embodying features of the present invention;

FIG. 2 is a front view of the hose end timer of FIG. 1;

FIG. 3 is a top view of the hose end timer of FIG. 1;

FIG. 4 is a bottom view of the hose end timer of FIG. 1;

FIG. 5 is a side elevational view of the hose end timer of FIG. 1;

FIG. 6 is a cross-sectional view of the hose end timer of FIG. 1;

FIG. 7 is a top exploded view of the hose end timer of FIG. 1;

FIG. 8 is a bottom exploded view of the hose end timer of FIG. 1;

FIG. 9 is a front view of a solenoid-actuated valve assembly of the hose end timer of FIG. 1;

FIG. 10 is a cross-sectional view of the solenoid-actuated valve assembly of the hose end timer of FIG. 9;

FIG. 11 is a front view of the valve body and inlet and outlet components of the hose end timer of FIG. 1;

FIG. 12 is a side elevational view of the valve body and inlet and outlet components of FIG. 11;

FIG. 13 is a cross-sectional view of the valve body and inlet and outlet components of FIG. 11; and

FIG. 14 is an exploded view of the valve body and inlet and outlet components of FIG. 11;

FIG. 15 is a perspective view of the valve body of FIG. 11 showing the lower end of the valve body;

FIG. 16 is a bottom perspective view of an outlet shown in FIG. 11;

FIG. 17 is a front view of the outlet of FIG. 16;

FIG. 18 is a top view of the outlet of FIG. 16;

FIG. 19 is a top perspective view of the outlet of FIG. 16;

FIG. 20 is a perspective view of the valve body and outlet, as assembled, of FIG. 11;

FIG. 21 is a partial cross-sectional view of FIG. 1 showing the connection of the outlet, valve body, and housing; and

FIG. 22 is a cross-sectional view of the hose end timer of FIG. 1 showing the connection of the outlet, valve body, and housing.

### DESCRIPTION OF THE PREFERRED EMBODIMENTS

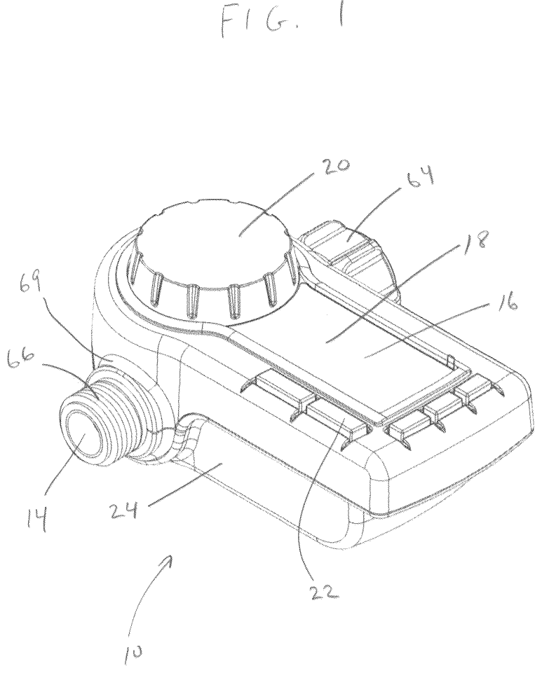

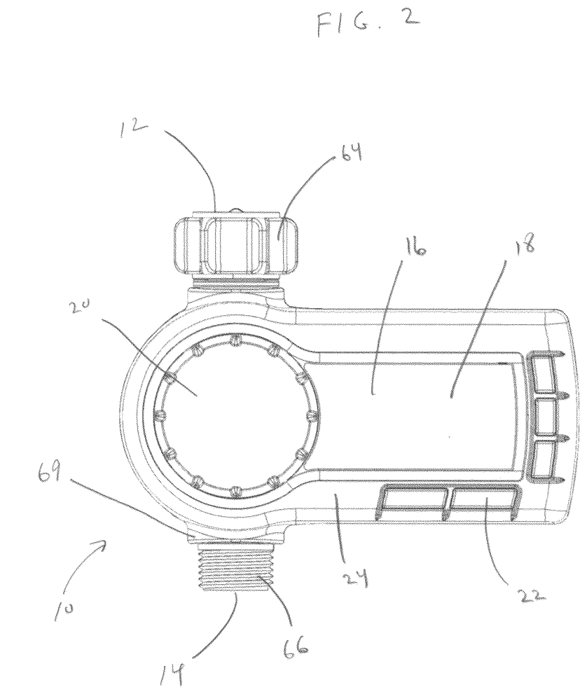

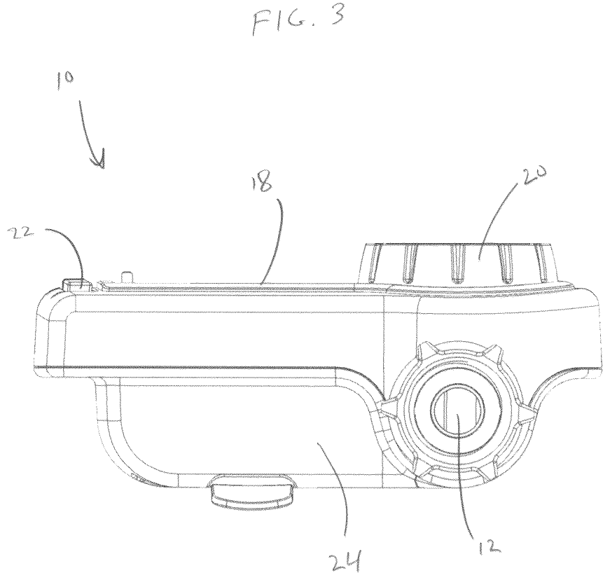

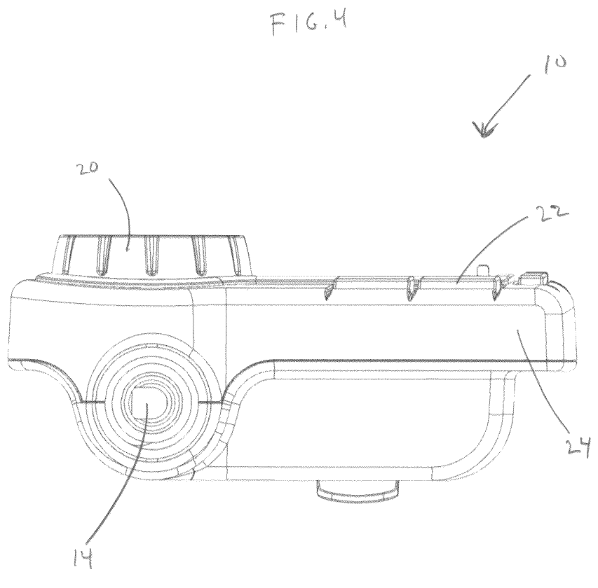

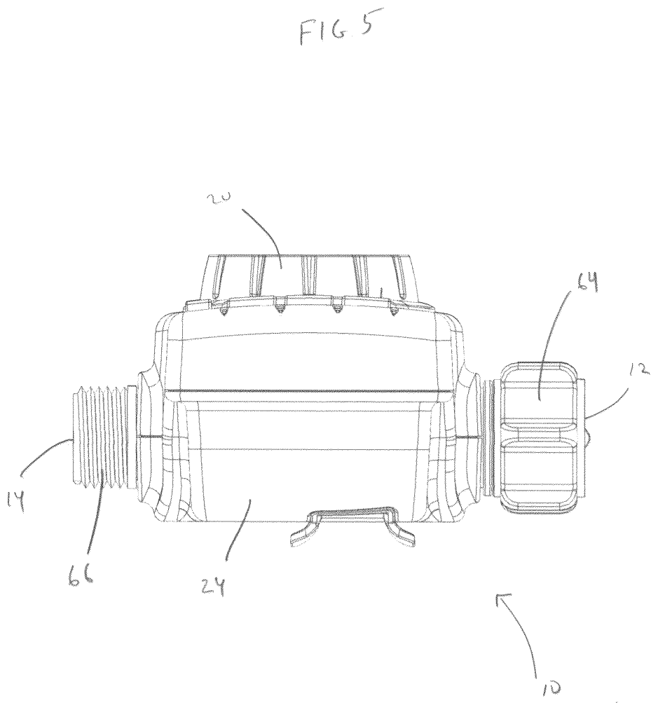

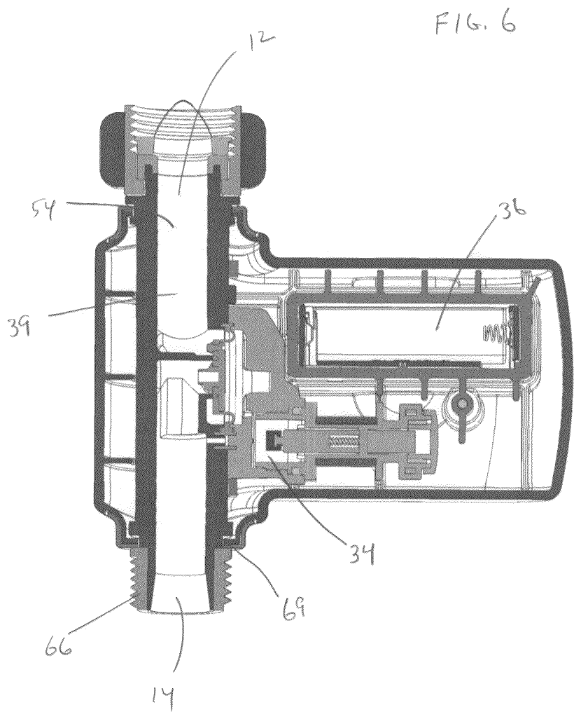

With respect to FIGS. 1-8, an irrigation device in the form of a hose end timer 10 is shown for use in scheduling the delivery of irrigation water or fluid from a water source and through the hose end timer 10. In one form, it is contemplated that one end of the hose end timer 10 may be connected to a faucet spigot, such as may be located on the exterior of a house or building. The other end of the hose end timer 10 may be connected to a hose, which in turn may be coupled to an emission device. The hose end timer 10 is used to schedule and control the flow of water from the faucet spigot to and through the hose.

As shown in FIGS. 1-8, in one preferred form, the hose end timer 10 includes an inlet 12, an outlet 14, and a user interface 16. A user may connect the inlet 12 to a standard hose faucet spigot and connect the outlet 14 to one end of a hose, such as, for example, a standard garden hose. In turn, the other end of the hose may be attached to an irrigation device. The hose end timer 10 generally allows the user to provide input through the user interface 16 to adjust various settings, such as, for example, adjusting a clock, automatic/manual operation, the time for irrigation, the duration of the irrigation, the frequency of irrigation, and a rain delay.

The user interface 16 preferably includes an electronic display screen 18, a rotary dial 20 (or mode knob), and push buttons 22. The display screen 18 is covered by a protective and transparent covering (or film) 19 and shows relevant timer information, such as, for example, time of day, day of the week, and the battery power level. The transparent covering 19 may be removed upon installation of the hose end timer. The rotary dial 20 allows a user to select a mode for setting timer information, including, for example, setting the clock, the start time, and the duration of irrigation. Push buttons 22 on the interface 16 allow the user to adjust the settings up and down. Other push buttons 22 may provide a manual override to allow the user to irrigate immediately or to set a rain delay.

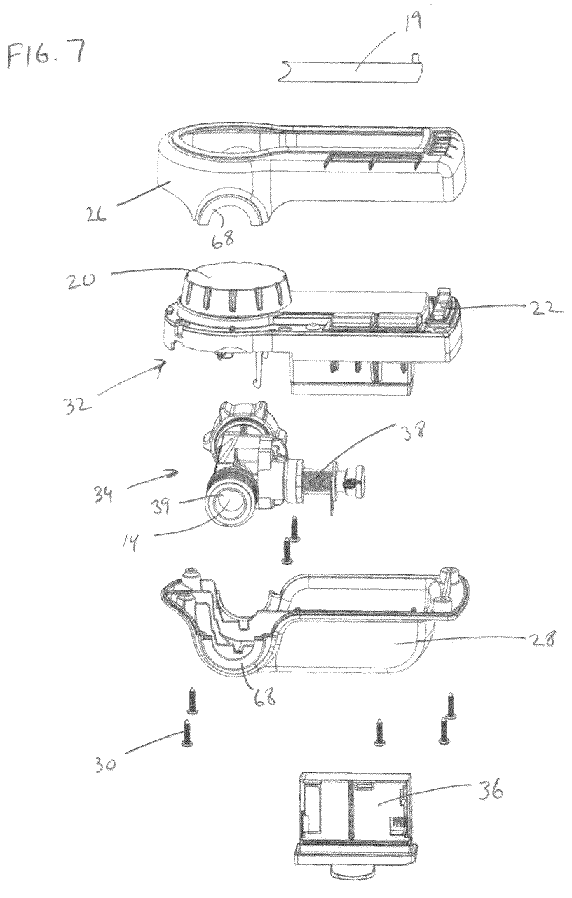

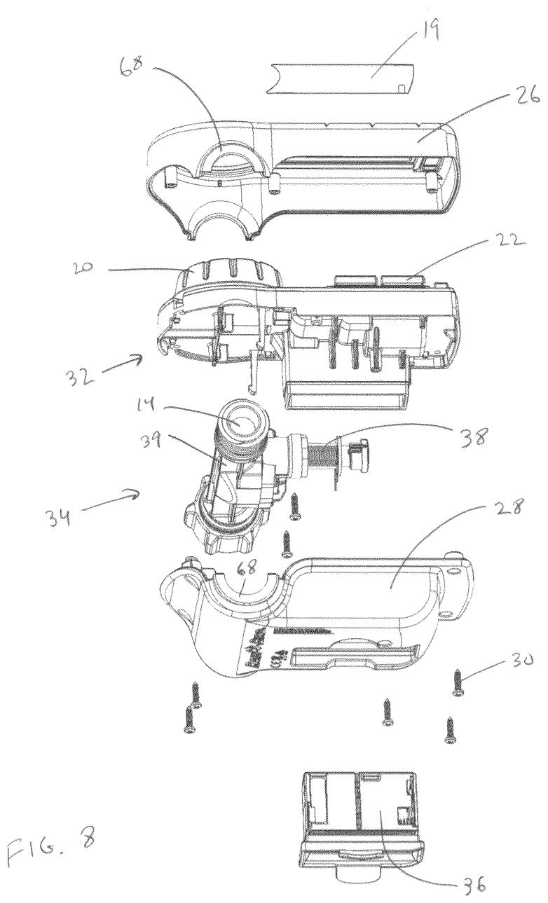

The housing 24 of the hose end timer 10 contains and protects the components therein. As shown in FIGS. 7 and 8, the housing 24 is preferably composed of an upper housing 26 and a lower housing 28 that are fastened to one another by screws 30 or other fasteners. In this particular example, the hose end timer 10 also includes an inner shelf assembly 32, a solenoid-actuated valve assembly 34, and a removable battery tray 36 that may be inserted through the lower the housing 28.

The inner shelf assembly 32 supports the rotary dial 20 and push buttons 22 thereon, and it preferably includes a circuit board disposed therein. The circuit board provides the control circuitry for opening and closing the valve assembly 34 in response to user input and commands. Among other things, the control circuitry opens and closes the valve assembly 34 to allow irrigation at predetermined times for predetermined durations. Batteries preferably provide the power source for actuation of the valve assembly 34. The power demand of the valve assembly 26 is preferably low in order to maximize battery life.

Various features, settings, and functionality (such as, for example, a manual override) have been described above. It should be understood, however, that these are simply examples and are not intended as limitations on the irrigation device. Some or all of the above features and settings are not required in the irrigation device. In certain forms, it is contemplated that a limited number of features and settings may be incorporated into the irrigation device, as desired. Further, in other forms, additional or different features and settings may be utilized in the irrigation device.

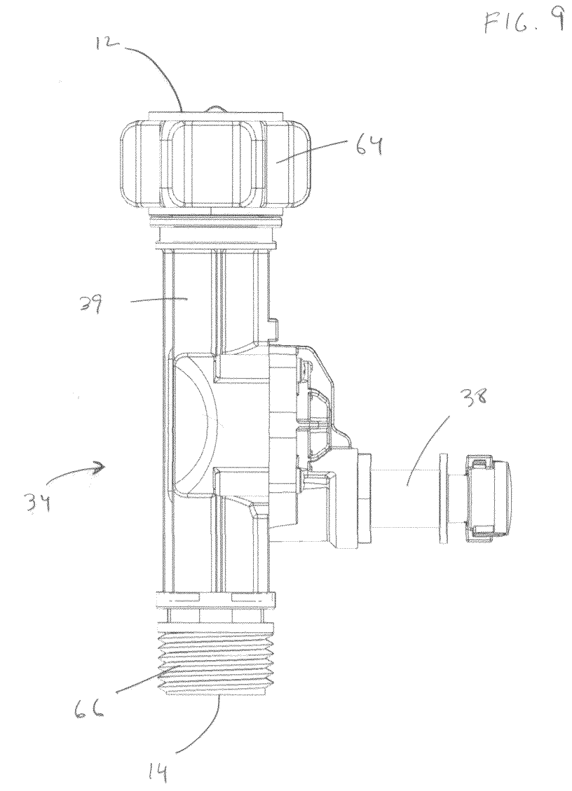

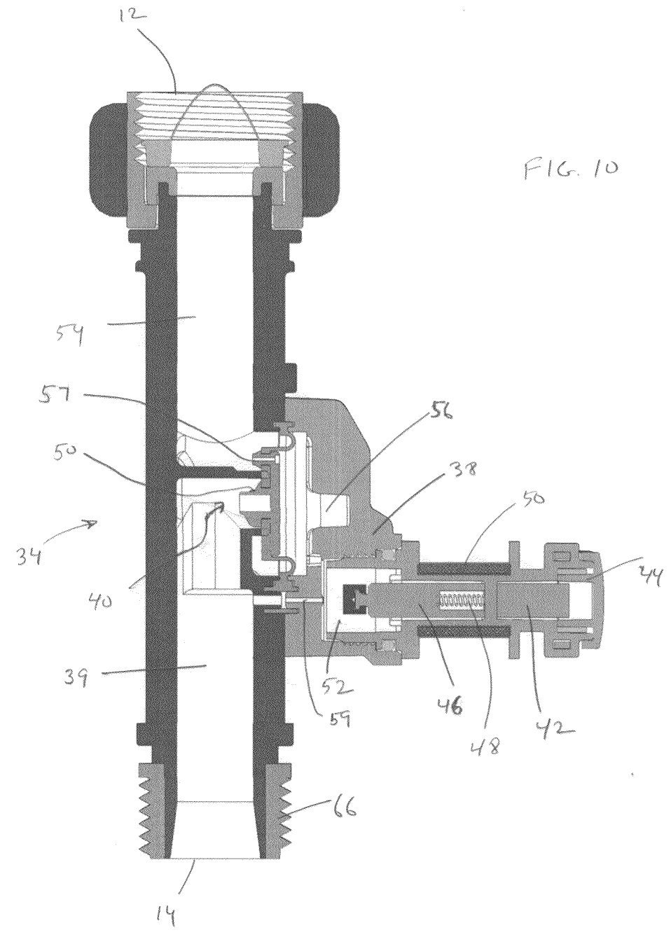

One preferred form of a solenoid-actuated valve assembly 34 is shown in FIGS. 9 and 10. The figures show the inlet 12 at the top (which may be connected to an outdoor spigot) with the outlet 14 at the bottom (which may be connected to a hose). The valve assembly 34 disposed within the housing 24 preferably uses a magnetically-actuated latching solenoid 38 moving back and forth to open and close the valve 40.

The valve assembly 34 includes a solenoid 38, a valve body 39, the inlet 12, and the outlet 14. In the solenoid 38, a magnet 42 moves to the left to hold a plunger 46 in an open position (shown in FIG. 10) and moves to the right (with respect to the figure) when the plunger 46 is in a closed position. When the valve 40 is in the closed position, the magnet 42 is coupled to a metal member 44. In this rightward position, the magnet 42 is distant from the plunger 46 such that the spring 48 biases the plunger 46 to the left to close the valve 40.

When the coil 50 is energized (in response to a signal to initiate irrigation), the plunger 46 is pulled to the right against the bias of the spring 48, thereby opening the valve 40. In this position, the plunger 46 attracts the magnet 42 such that the magnet 42 is pulled to the left away from the metal member 44. The magnet 42 holds the plunger 46 in this open position, thereby holding the valve 40 open for the duration of irrigation.

When the coil 50 is energized again in the reverse direction (in response to a signal to stop irrigation), the plunger 46 is pushed to the left with the bias of the spring 48, thereby closing the valve 40. When the plunger 46 is in this closed position, the magnet 42 is attracted to and moves to the right to contact the metal member 44. In this rightward position, the magnet 42 does not exert sufficient force to overcome the bias of the spring 48 on the plunger 46, and the spring 48 continues to bias the plunger 46 to the leftward (or closed) position, holding the valve 40 closed.

Movement of the plunger 46 opens and closes the valve 40 by coupling the plunger 46 to a diaphragm 50 that opens and closes the valve 40. The diaphragm 50 is spaced from a valve seat 51 in the open position and is engaged with the valve seat 51 in the closed position. The plunger 46 moves laterally in a plunger chamber 52 that is axially offset from the diaphragm 50, i.e., the plunger chamber 52 is below and to the right of the diaphragm 50. The plunger chamber 52 is in fluid communication with the diaphragm 50 and a pressure chamber 56. The diaphragm 50 is biased to block flow in the conduit 54 (or flow passage) between the inlet and outlet 12, 14, and the valve 40 is closed.

When the plunger 46 is in the leftward (or closed) position, water flows from the inlet 12 and into the pressure chamber 56 via a bleed flow passage 57. Water can flow into the plunger chamber 52, but when the plunger 46 is in the leftward (or closed) position, it cannot flow out to the conduit 54. The diaphragm 50 remains biased to the closed position (to the left) against the valve seat 51, and the valve 40 remains closed.

When the plunger 46 is in the rightward (or open) position, water again flows from the inlet 12 and into the pressure chamber 56 via the bleed flow passage 57 and then into the plunger chamber 52. However, when the plunger 46 is in the rightward (or open) position, water can now flow out to the conduit 54 via a vent flow passage 59. In other words, a certain amount of water can flow from the pressure chamber 56 to the plunger chamber 52 to the conduit 54. This flow results in a pressure drop in the pressure chamber 56 such that pressure exerted against the diaphragm 50 from the inlet water moves the diaphragm 50 away from the valve seat 51, thereby opening the valve 40 and allowing fluid to flow through the valve 34 from the inlet 12 to the outlet 14. In FIG. 10, the plunger has just been moved to the rightward (or open) position, but the diaphragm 50 has not yet moved to an open position.

It should be understood that the solenoid-actuated valve assembly 34 described above is just one example of a valve assembly that may be used with the hose end timer or with other irrigation devices. Other solenoid arrangements are shown in U.S. Pat. Nos. 5,213,303; 7,201,187; and 7,503,348, which are incorporated herein by reference in their entirety. Further, in certain forms, it is contemplated that other types of valves and valve assemblies may be used with the hose end timer or with other irrigation devices that do not involve solenoids.

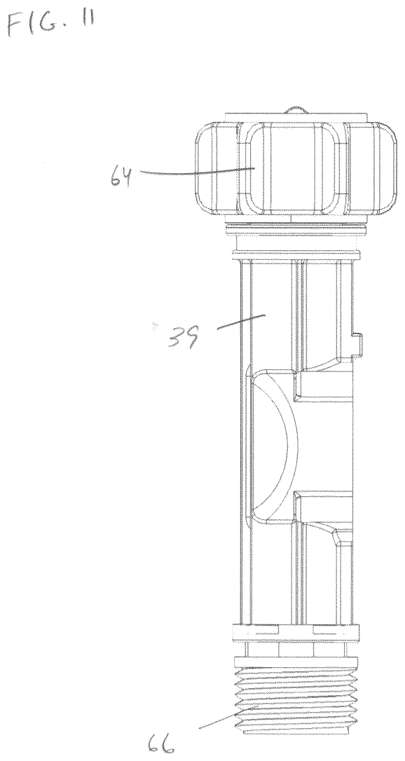

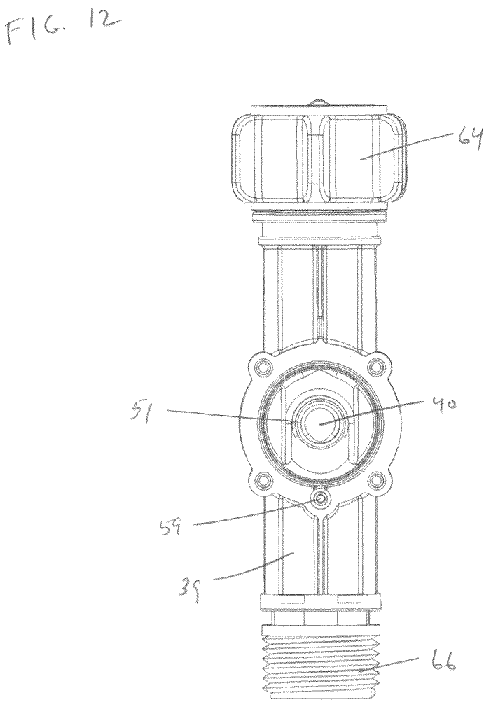

FIGS. 11-14 show the valve body 39 and inlet and outlet components of the valve assembly 34. The inlet components preferably include a filter screen 58, a collar coupler 60, an internally threaded ring 62, and an external collar 64. The filter screen 58 filters out grit and other debris flowing into the inlet 12 that might otherwise clog the hose end timer 10. The collar coupler 60 is seated within the threaded ring 62 below the threading. The filter screen 58 sits on top of the collar coupler 60 and is retained by the threading in ring 62. The collar coupler 60 is preferably mounted to an upper portion of the valve body 39 by receiving a raised annular rim 61 of the valve body 39 therein. The threaded ring 62 is preferably formed of a suitable metal material to resist damage to the threading (such as stripped threading or cross-threading) that may occur over time. The external collar 64 is preferably formed of a plastic and/or rubber material that is preferably bonded around the threaded ring 62. The external collar 64 allows the user to rotate the internally threaded ring 62 onto the external threading of a faucet spigot.

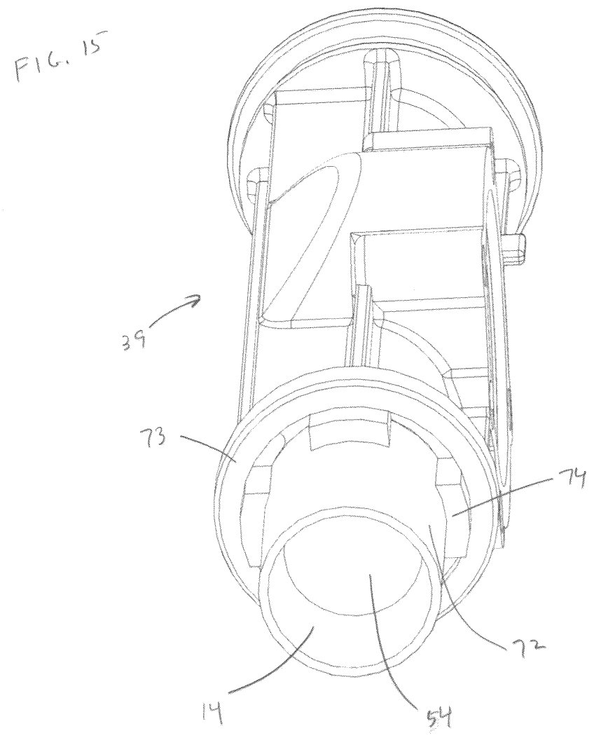

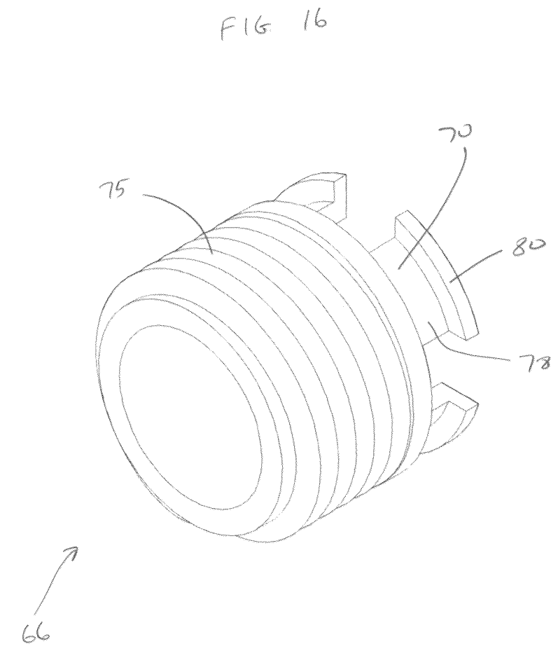

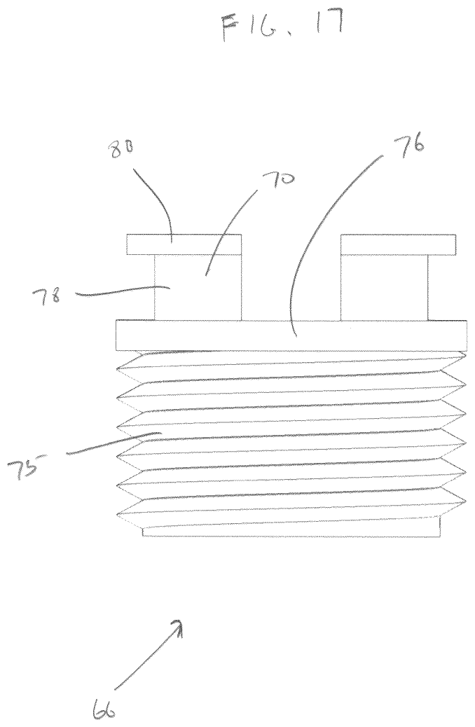

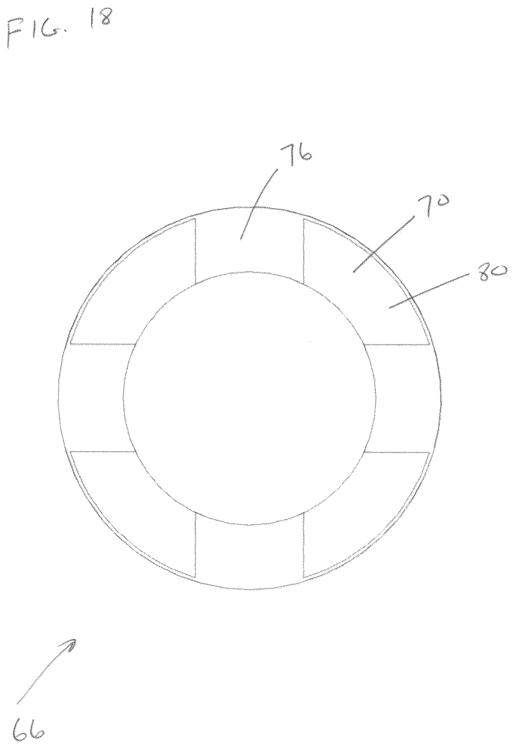

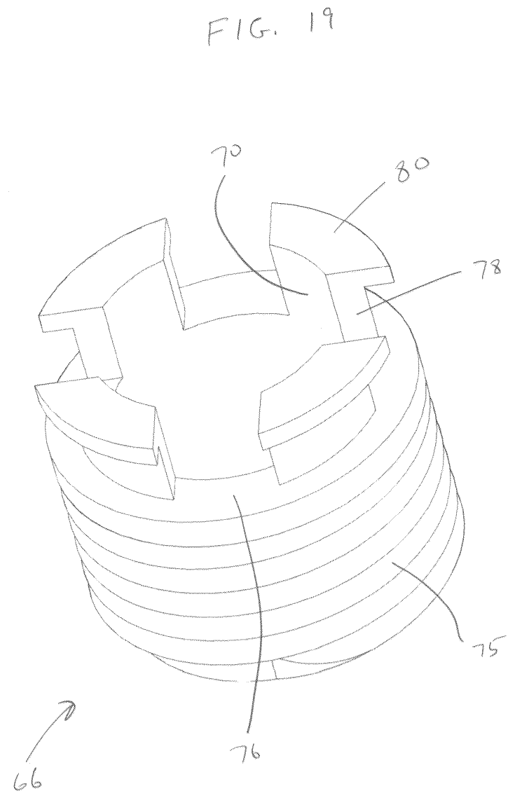

FIG. 15 shows a view of the unassembled valve body 39, and FIGS. 16-20 show various views of the unassembled outlet body 66. The valve body 39 is preferably formed of a plastic material, while the outlet body 66 is formed of a metal material. The valve body 39 and the outlet body 66 are preferably bonded to one another by an insert molding process. More specifically, the outlet body 66 (which functions as an externally threaded metal collar) is inserted in the mold for the valve body 39 and molded onto the valve body 39 during the molding process. This insertion molding process makes the bodies 39, 66 an integral component, thereby creating strength as well as sealing the flow through the outlet 14. Additionally, the housing 24 includes structure to help locate and retain the outlet body 66 in the correct position.

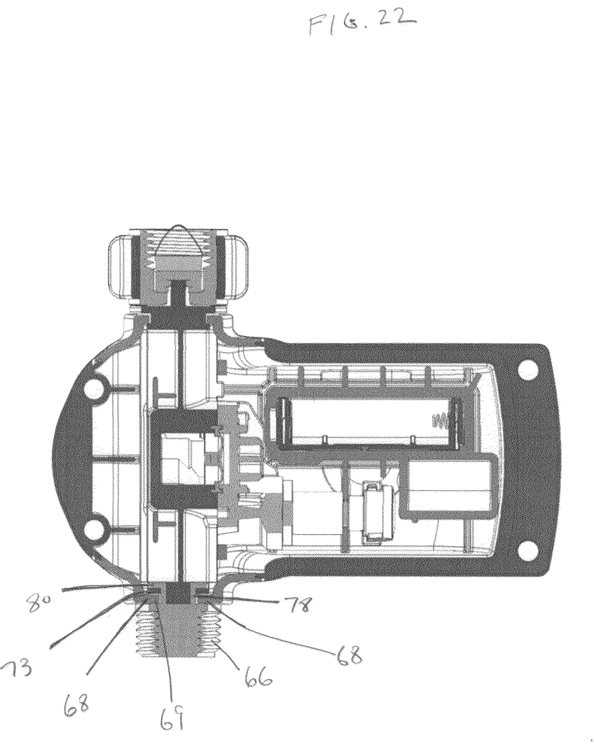

As shown in FIG. 22, the upper housing 26, the lower housing 28, the valve body 39, and the outlet body 66 cooperate to create a secure coupling. The upper housing 26 and lower housing 28 each include a semicircular rim 68 such that, when assembled, the two pieces define an outlet aperture 69 of a predetermined radius. As shown in FIG. 22, this radius is selected such that semicircular rims 68 engage upwardly projecting towers 70 of the outlet body 66. Further, when assembled, these semicircular rims 68 are disposed between portions of the valve body 39 and the outlet body 66, as addressed further below, to establish a secure coupling of these components.

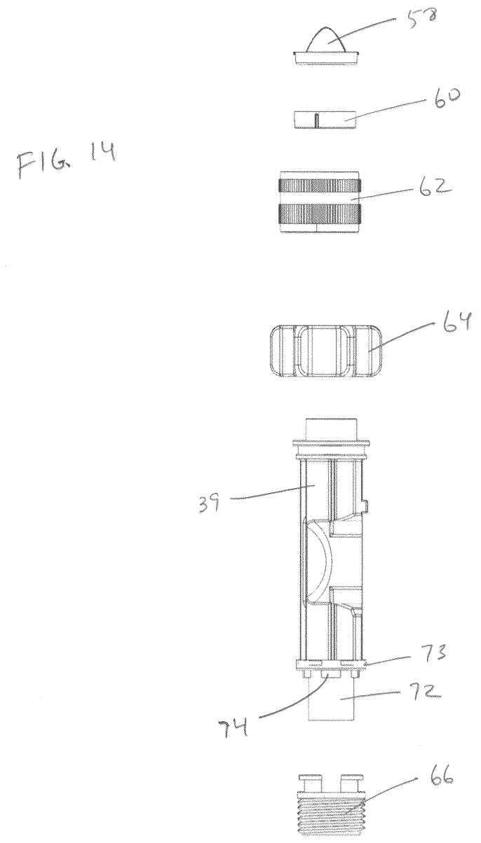

As shown in FIGS. 14 and 15, the lower end of the valve body 39 includes an annular cylindrical portion 72 that defines part of the conduit 54. An annular flange 73 projects radially outwardly and is adjacent to and above tabs 74. In this preferred form, the height of each tab 74 corresponds generally to the thickness of the semicircular rims 68 of the upper and lower housings 26, 28.

The tabs 74 are preferably spaced equidistantly about the annular cylindrical portion 72 and project radially outwardly therefrom. In this form, there are four tabs 74 that are spaced circumferentially about the annular cylindrical portion 72 so as to form gaps through which portions of the outlet body 66 extend. M ore specifically, the tabs 74 are sized and spaced to allow a tower 70 to extend upwardly between each set of two adjacent tabs 74.

FIGS. 16-19 show different views of the outlet body 66. The outlet body 66 includes external threading 75 for coupling to the internal threading of a hose. The outlet body 66 is preferably in the form of a castellated insert that includes a certain number of towers 70 that project upwardly from an annular ledge 76. The number of towers 70 preferably corresponds to the number of tabs 74, and in this example, there are four towers 70. Each tower 70 includes an upright portion 78 that extends upwardly a predetermined vertical distance from the annular ledge 76. Each upright portion 78 extends between adjacent tabs 74 and terminates in an overhanging portion 80. In this example, the overhanging portions 80 extend radially outwardly such that they overhang the annular ledge 76. The overhanging portion 80 may extend in a direction parallel to the annular ledge 76 or in another direction that otherwise embeds it in the valve body 39.

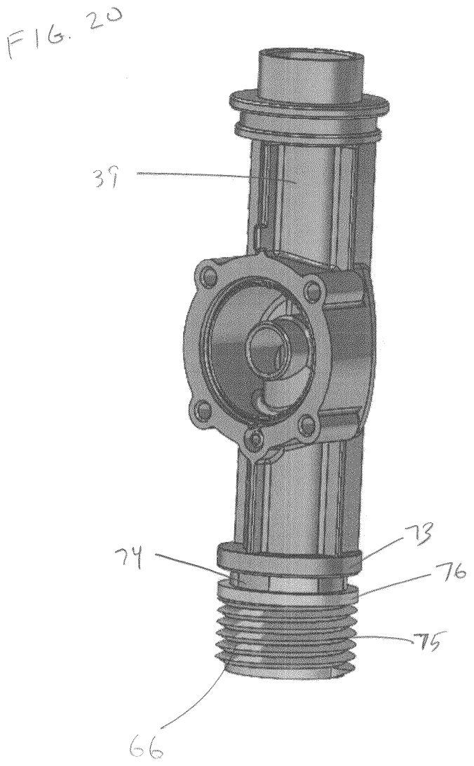

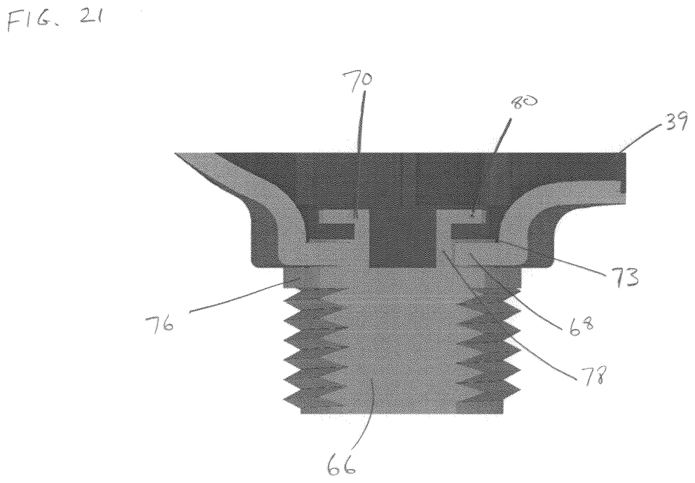

As shown in FIGS. 20-22, the towers 70 on the castellated outlet body 66 hold the outlet body 66 relative to the valve body 39. The spaces between the upright portions 78 of the towers 70 are preferably filled with plastic material of the valve body 39, i.e., tabs 74, to prevent the outlet body 66 from rotating. As can be seen in FIG. 21, the overhangs 80 are encapsulated within the annular flange 73 of the valve body 39. Thus, the overhangs 80 at the top of the towers 70 are supported by plastic material below the overhangs 80 to prevent the outlet body 66 from pulling off of the valve body 39. Next, the housing 24 also fills a portion of the gap between the over-molded plastic about the overhang 80 and the annular ledge 76 of the outlet body 66. Also, when assembled, the semicircular rims 68 (of the upper and lower housings 26, 28) are received between the annular flange 73 (of the valve body 39) and the annular ledge 76 (of the outlet body 66).

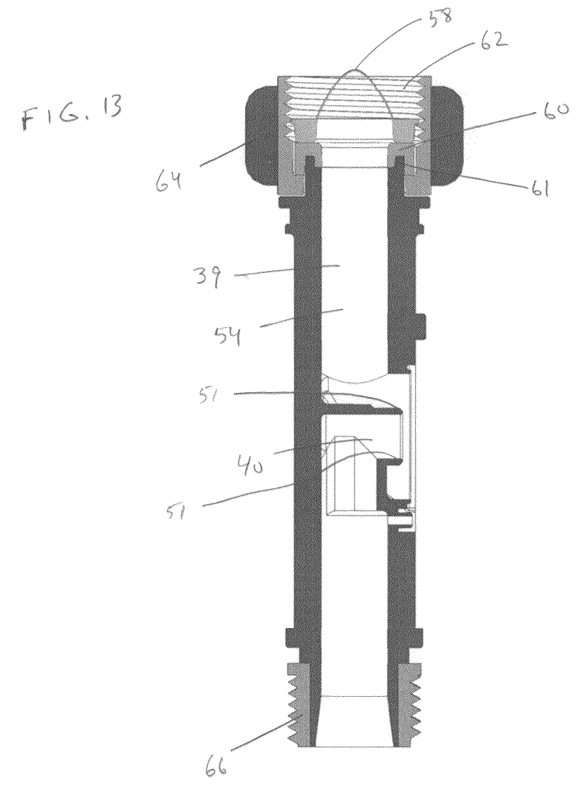

As shown in FIGS. 13 and 22, the annular cylindrical portion 72 of the valve body 39 has a smaller radius than the outlet body 66 such that this annular cylindrical portion 72 engages an inner surface of the outlet body 66. In other words, the annular cylindrical portion 72 is disposed within the outlet body 66. Further, the annular cylindrical portion 72 and the outlet body 66 are coextensive in length. More specifically, the annular cylindrical portion 72 extends, at least, to the bottom of the outlet body 66 so that the flow path is not compromised by a metal to plastic interface that could result in leakage. In other forms, the annular cylindrical portion 72 may extend slightly beyond the outlet body 66 so that water flowing along the flow path is completely encased by the plastic interface. In addition, the thickness of the annular cylindrical portion 72 preferably decreases towards the bottom end of the outlet body 66 to allow clearance for a mating connection with a hose.

One advantage of this design is that it minimizes the machining necessary to produce the outlet body 66. For example, a lathe can create the overall shape and threads, and the castellation can be created on a mill by cutting two channels. Other designs require significantly more work to produce. Although minimizing the needed machinery, the outlet body 66, in combination with the valve body 39 and the housing 24, results in a secure coupling. Further, this outlet body 66 reduces leakage that may otherwise occur over time.

It should be understood that the hose end timer 10 described above is just one example of an irrigation device that may utilize some of the claimed subject matter. It is also contemplated that other irrigation devices might also be used. It is contemplated that other irrigation devices may includes two housing portions configured for engagement with one another to define a housing and that together define an inlet and an outlet. Further, other irrigation devices may utilize a molded body disposed within the housing and defining a flow passage from the inlet to the outlet and may utilize a metal outlet body comprising a threaded portion and at least one projection embedded at least partially into the molded body for coupling the metal outlet body to the molded body.

It will be understood that various changes in the details, materials, and arrangements of parts and components which have been herein described and illustrated in order to explain the nature of the irrigation devices, irrigation valve assemblies, and outlets may be made by those skilled in the art within the principle and scope of the irrigation devices and components thereof, as expressed in the appended claims. Furthermore, while various features have been described with regard to a particular embodiment or a particular approach, it will be appreciated that features described for one embodiment also may be incorporated with the other described embodiments.

What is claimed is:

1. An irrigation device comprising:
an inlet portion made of plastic;
an outlet portion made of plastic and in fluid communication with the inlet portion; and
a metal body located at least one of the inlet portion and the outlet portion, the metal body including at least one metal projection embedded at least partially into the at least one of the inlet portion and the outlet portion to attach the metal body thereto and a threaded metal portion;
wherein the threaded metal portion is fixed against rotation relative to the at least one of the inlet portion and the outlet portion.

2. The irrigation device of claim 1, wherein a conduit extends between the inlet portion and the outlet portion.

3. The irrigation device of claim 1, wherein the metal body is at the outlet portion.

4. The irrigation device of claim 2, wherein the conduit is connected to both the inlet portion and the outlet portion.

5. The irrigation device of claim 1, wherein the inlet portion comprises an internally threaded metal ring for coupling to a water source.

6. The irrigation device of claim 5, wherein the inlet portion further comprises an external collar over-molded about the internally threaded metal ring.

7. The irrigation device of claim 1, wherein the metal body comprises an annular ledge adjacent the threaded metal portion of the metal body, the at least one metal projection extending from the annular ledge in a direction opposite from the threaded metal portion.

8. The irrigation device of claim 7, wherein the at least one metal projection comprises at least two metal projections spaced about and extending from the annular ledge in a direction opposite from the threaded metal portion.

9. The irrigation device of claim 7, wherein a metal projection comprises a first portion extending away from the annular ledge in a first direction and a second portion extending away from the first portion in a second direction.

10. The irrigation device of claim 9, wherein the second portion of the metal projection is embedded within the at least one of the inlet portion and the outlet portion to prevent axial movement of the metal body.

11. The irrigation device of claim 10, wherein:
the at least one of the inlet portion and the outlet portion comprises an annular portion with a plurality of tabs spaced about and extending outwardly from the annular portion, a number of tabs corresponding to a number of metal projections of the metal body.

12. The irrigation device of claim 11, wherein the first portion of the metal projection is disposed between adjacent tabs to prevent rotational movement of the metal body.

13. The irrigation device of claim 1 wherein at least a portion of the at least one of the inlet portion or the outlet portion overlaps with a portion of the threaded metal portion.

14. The irrigation device of claim 13 wherein the overlapped portion of the at least one of the inlet portion or the outlet portion tapers.

15. The irrigation device of claim 1 wherein the at least one of the inlet portion and the outlet portion includes a projection that abuts the metal body to prevent axial movement in at least one direction.

16. The irrigation device of claim 1, wherein the at least one metal projection is arcuate.

17. The irrigation device of claim 1, wherein the at least one of the inlet portion and the outlet portion includes a first segment with a first outer diameter dimension and a second segment with a second outer diameter dimension, the first outer diameter dimension being different than the second outer diameter dimension.

18. An irrigation device comprising:
an outlet; and
a conduit coupled to the outlet and defining, at least in part, a flow passage;
wherein the outlet comprises a metal body, the metal body including a threaded metal portion and at least one metal projection embedded at least partially into the conduit for coupling the metal body to the conduit;
wherein the threaded metal portion is fixed against rotation.

19. The irrigation device of claim 18, wherein the conduit comprises a molded plastic body.

20. The irrigation device of claim 19, wherein the metal body comprises an annular ledge adjacent the threaded metal portion of the metal body, the at least one metal projection extending from the annular ledge in a direction opposite from the threaded metal portion.
